(19) United States
(12) Patent Application Publication
(10) Pub. No.: US 2008/0099614 A1
(43) Pub. Date: May 1, 2008

(54) UNITARY ONE-PIECE WINDSHIELD

(76) Inventors: Linden S. Blue, Del Mar, CA (US); Daniel E. Cooney, Springville, UT (US)

Correspondence Address: NYDEGGER & ASSOCIATES, 348 OLIVE STREET, SAN DIEGO, CA, 92103, US

(21) Appl. No.: 11/549,878

(22) Filed: Oct. 16, 2006

(51) Int. Cl. B64C 1/14

(52) U.S. Cl. 244/129.3

(57) ABSTRACT

A windshield for a pressurized aircraft includes a single transparent unit that functions structurally to allow pressurization of the aircraft and to support the aircraft's fuselage in response to external loads. The windshield also functions operationally to provide the pilot with an unobstructed field of vision through an extended arc of more than two hundred degrees. For its manufacture, layers of the transparent unit are respectively bent along a straight center line to establish two curved portions that are symmetrical relative to a common plane. The layers are then laminated.

### FIELD OF THE INVENTION

The present invention pertains generally to cockpit windshields for aircraft. More particularly, the present invention pertains to aircraft cockpit windshields having a unitary construction. The present invention is particularly, but not exclusively, useful as a windshield for the cockpit of a pressurized aircraft that acts as a structural member for the fuselage and that surrounds the pilot to provide an unobstructed field of vision through an extended visual arc.

### BACKGROUND OF THE INVENTION

In addition to the obvious purpose of providing outside visibility for the crew, a cockpit windshield can, and sometimes must, perform several other functions. For one, the windshield may serve as a load bearing member that responds to external forces imposed on the aircraft, such as the forces that are exerted on the nose gear as the aircraft is landed. In this case, in order to withstand the landing forces, the windshield must be strong in compression, and be able to avoid buckling. For another, the windshield provides protection against objects that might impact against it, particularly in flight (e.g. bird strikes). Here, the windshield must have sufficient resilience and flexibility to deform and absorb the blow, and then return to its pre-impact configuration. Further, in the case of a pressurized aircraft, the windshield must be effectively incorporated into the wall of a pressure vessel (i.e. the cabin of the aircraft).

Pressurized aircraft are designed with the objective of providing an environment that is compatible with normal human activity. In general, this requirement includes both oxygen and pressure considerations, and is typically referred to in terms of cabin pressure altitude. In context, normal atmospheric pressure, at sea level, is around fifteen pounds per square inch (15 psi). Clearly, aircraft can be flown without pressurization. According to Federal Aviation Regulations (FAR), however, oxygen requirements are imposed for flights above 12,500 feet (MSL). Accordingly, when aircraft are flown at high altitudes (i.e. at 12,500 feet and above) pressurization systems are frequently used to create cabin pressure altitudes that typically remain in a range of 5-10,000 feet (MSL). To do this, a differential pressure is established between the actual altitude of the aircraft (i.e. outside) and the cabin pressure altitude (i.e. inside). This differential is expressed in pounds per square inch, and can be more than 12 psid. Insofar as the cockpit windshield is concerned, a pressure differential of this magnitude (i.e. 12 psid) will exert a significant distributed force over the surface of the windshield that is proportional to its exposed area. Clearly, the windshield must be able to resist the forces that result from this pressure.

In light of the above, it is an object of the present invention to provide a cockpit windshield for an aircraft that is of a unitary construction, and that will provide crew members in the cockpit with an unobstructed field of vision through an arc of about 220°. Another object of the present invention is to provide an aircraft windshield that will structurally respond to externally imposed forces on the aircraft (e.g. landing forces and bird strikes). Yet another object of the present invention is to provide a cockpit windshield, of unitary construction, that can be effectively incorporated as part of the pressure vessel for an aircraft cabin. Still another object of the present invention is to provide a cockpit windshield of unitary construction that is reliable for its intended purposes, is relatively easy to manufacture and is comparatively cost effective.

### SUMMARY OF THE INVENTION

In accordance with the present invention, a cockpit windshield for an aircraft is manufactured and installed as a single transparent unit. Structurally, the windshield is made of various preformed layers that are laminated together to create the unit. Functionally, the windshield provides an extended and unobstructed field of vision for the crew, and it serves as a load-bearing member of the aircraft's fuselage.

To manufacture a windshield in accordance with the present invention, five separate, flat layers are pre-cut to a substantially same, predetermined shape. Two of the layers are cut from a polycarbonate material (about ⅜ inch thick), two are cut from an acrylic material (about ⅛ inch thick), and the fifth layer is made from a Mylar® material (about 5/1000 inch thick) in which a metallic heating element (e.g. wires or foil sheet) has been embedded. Each of the flat layers is then transformed into a predetermined three-dimensional configuration. Preferably, this is done as a so-called “flat wrap.”

In order to accomplish the flat wrap, a straight center line is identified for each layer. Specifically, this center line bifurcates the layer into substantially identical first and second portions. The layer is then positioned on a form and is bent around its center line. The result is a configuration for the layer wherein the first portion is symmetrical to the second portion. Preferably, the flat wrap is accomplished at a temperature that is in a range between 300-350 F°. After the flat wrap has been accomplished, the layer is formed as a continuous curve, without any compound curves. It is to be appreciated, however, that compound curves may be provided for the windshield, if desired.

Once the layers have been configured as disclosed above, an adhesive (e.g. polyurethane) is used to laminate the various layers together, to thereby create the single transparent unit. In this process, though not necessarily in the order presented here, the heating layer is bonded to one of the acrylic layers (hereinafter the outer layer). A first polycarbonate layer is then positioned against the outer layer, opposite the heating layer, and is bonded to the outer layer. A second polycarbonate layer is then bonded to the first layer. Finally, the remaining acrylic layer (hereinafter the inner layer) is bonded to the second polycarbonate layer. Together, these laminated layers create the transparent unit, with an edge.

After the polyurethane adhesive has been applied between juxtaposed layers, a vacuum bag is installed along the edge of the unit. The vacuum bag is then activated to establish a pressure along the edge of the unit that is preferably below about twenty five inches of mercury. Next, the combined unit and vacuum bag are put into an autoclave. In the autoclave, the unit is subjected to a pressure greater than about fifty pounds per square inch (>50 psi). This continues for about an hour. Also, during this time, the temperature inside the autoclave is maintained in a range between one hundred and eighty five degrees Fahrenheit and two hundred and sixty degrees Fahrenheit (185-260 F°). When the unit is removed from the autoclave, it is ready to be installed on the aircraft fuselage.

For the installation of the cockpit windshield on the aircraft fuselage, carbon frames are respectively bonded to the first and second polycarbonate layers, along the edge of the unit. These carbon frames are then screwed or bolted onto the fuselage. When installed, the windshield provides the crew (pilot and copilot), when they are sitting in the cockpit of the aircraft, with an unobstructed field of vision that extends through an arc of approximately 220°.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an aircraft with a cockpit windshield of the present invention installed thereon;

FIG. 1A is an enlarged view of the cockpit windshield;

FIG. 2 is a flat plan view of a layer configuration used for the manufacture of the windshield of the present invention;

FIG. 3 is a side view of an aircraft incorporating the windshield of the present invention with portions broken away for clarity; and

FIG. 4 is a cross sectional view of the windshield installation mechanism as seen along the line 4-4 in FIG. 3.

### DESCRIPTION OF THE PREFERRED EMBODIMENTS

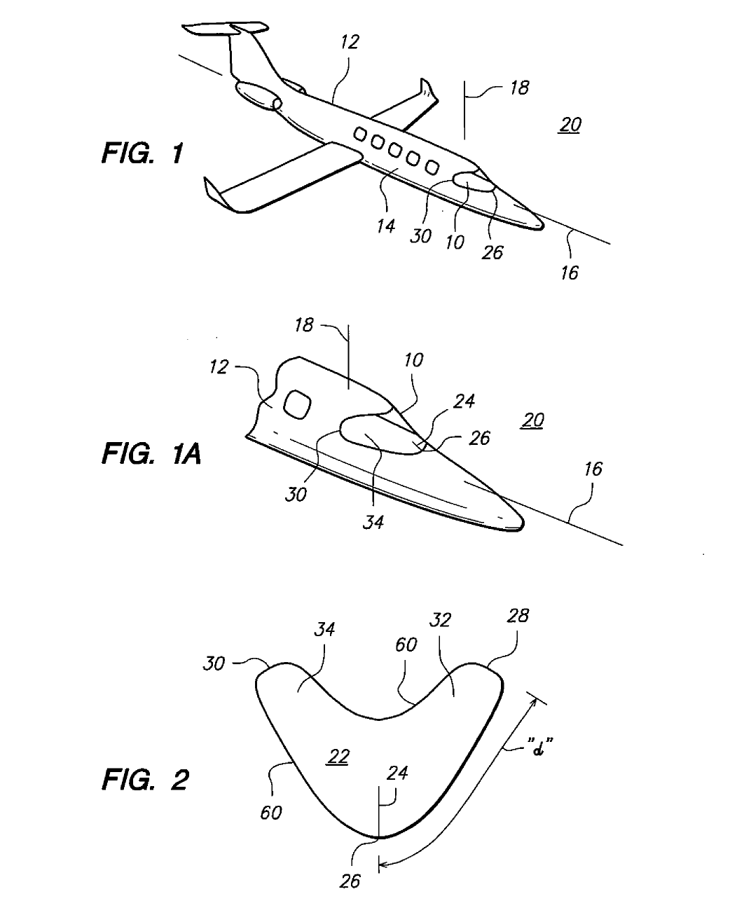

Referring initially to FIG. 1, a single unitary cockpit windshield 10 is shown installed on an aircraft 12 in accordance with the present invention. As shown, the windshield 10 is installed as a single unit to effectively surround the cockpit of the fuselage 14. For reference purposes, the aircraft 12 is shown to define a longitudinal axis 16 and an axis 18 that intersects the longitudinal axis 16. Together, the intersecting axes 18 and 16 define a central plane 20 that bifurcates the aircraft 12 into symmetrical halves, relative to the central plane 20. Also for reference purposes, an enlarged view of the cockpit portion of aircraft 12, with an installed windshield 10, is shown in FIG. 1A.

Referring now to FIG. 2, a template that is to be used in the manufacture of windshield 10 is shown as a layer 22, in a two dimensional configuration. As intended for the present invention, various layers 22 of different materials are initially cut in the two dimensional configuration shown in FIG. 2. They are then each subsequently formed into a three dimensional configuration. The reconfigured layers 22 are then laminated together to create the windshield 10 shown in FIG. 1A.

Dimensionally, each layer 22 defines a center line 24 that passes through a center point 26. FIG. 2 also shows that the layer 22 establishes an arcuate distance “d” that extends between the center point 26 and an end point 28. Similarly, a same distance “d” is established between the center point 26 and an end point 30. Accordingly, when a layer 22 is folded along its center line 24, each layer 22 is symmetrically bifurcated relative to the center line 24 into a first portion 32 and a second portion 34, each of length “d”.

In the manufacture of the windshield 10, various materials are each configured like layer 22. They are then preformed and laminated together to create the windshield 10. The windshield 10 is then installed on the aircraft 12. For this transformation, the relationship between the initial two dimensional configuration of layers 22, and their final three dimensional configuration, when installed on the aircraft 12 as its windshield 10, is best appreciated by cross referencing FIG. 1A with FIG. 2.

When considering FIG. 1A, together with FIG. 2, it will be appreciated that the windshield 10 is installed on the aircraft 12 with the center point 26 and the center line 24 both in the central plane 20. Thus, the portions 32 and 34 of windshield 10 are symmetrical to each other, relative to the central plane 20. Consequently, a pilot (not shown), when sifting in the cockpit of aircraft 12, has an extended field of vision that is unobstructed from the end point 28 and through the center line 24 to the end point 30. As a practical matter, this gives the pilot, and copilot, a full operational field of vision that extends through an arc of about 220°.

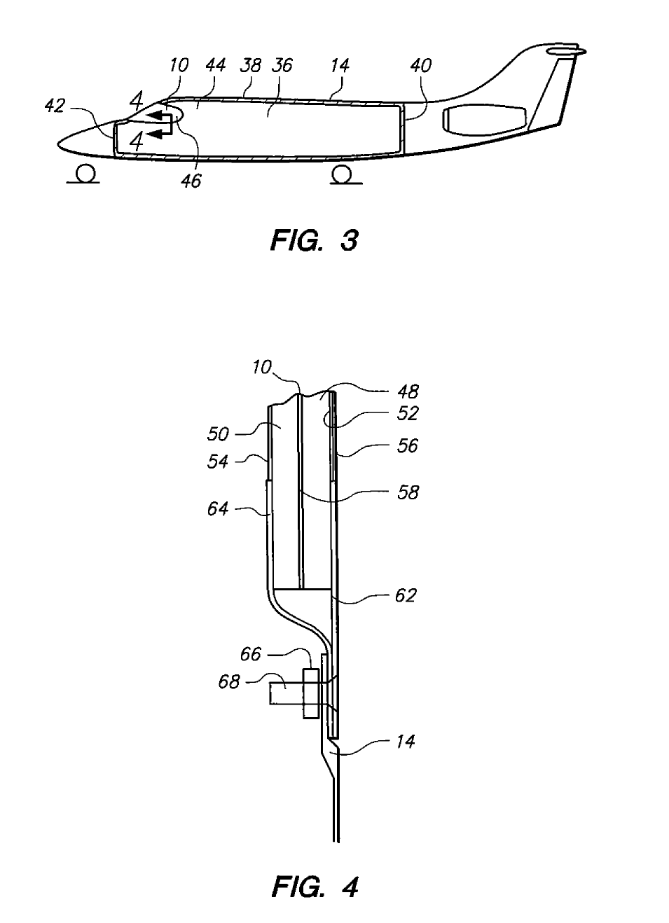

Turning now to FIG. 3, the fuselage 14 of aircraft 12 is shown with portions broken away to reveal the cabin 36 of the aircraft 12. As intended for the present invention, the cabin 36 is designed to withstand a pressure differential greater than approximately 10 psid. This will allow the aircraft 12 to fly at very high altitudes (e.g. 50,000 ft MSL). For this purpose, the cabin 36 must be sealed to act as a pressure vessel.

As shown in FIG. 3, the cabin 36 (i.e. pressure vessel) includes a substantially cylindrical shaped body section 38 that is closed by an aft bulkhead 40 at its tail end. At its nose end, the body section 38 of cabin 36 is integrated with a forward bulkhead 42. Further, the body section 38 is formed with an extension 44 that establishes a gap 46 which is created between the extension 44 and the forward bulkhead 42. In accordance with the present invention, the windshield 10 is installed in this gap 46. Importantly, when so installed, the windshield 10 structurally functions as a part of the wall of the cabin 36 (pressure vessel). Thus, as a structural part of a pressure vessel, the windshield 10 must be capable of withstanding various forces, in addition to its more obvious function of providing a field of vision for the crew (pilot and copilot) of the aircraft 12.

In the manufacture of windshield 10, FIG. 4 indicates that six separate components are involved. These are: a first polycarbonate layer 48, a second polycarbonate layer 50, an acrylic outer layer 52, an acrylic inner layer 54, a heating layer 56, and an intermediate layer 58. In their relationship to each other, the intermediate layer 58 is positioned between the first and second polycarbonate layers 48 and 50. The acrylic outer layer 52 is positioned against the first polycarbonate layer 48, opposite the intermediate layer 58 and, similarly, the acrylic inner layer 54 is positioned against the second polycarbonate layer 50. The heating layer 56 is then positioned against the acrylic outer layer 52.

For purposes of the present invention, the heating layer 56 is preferably made of a Mylar® material, with a metal foil or wires embedded therein to provide the necessary heating capability. Also, the intermediate layer 58 is preferably made of a polyurethane. Dimensionally, the polycarbonate layers 48 and 50 are each preferably about ⅜ inch thick. On the other hand, the acrylic outer layer 52, the acrylic inner layer 54, and the heating layer 56 are each preferably about one hundredth of an inch thick (0.01 in.). The intermediate layer 58 will be about five hundredths of an inch thick (0.05 in.).

As mentioned above, each of theses layers 48, 50, 52, 54, 56 and 58 all generally conform to a template layer 22. More specifically, as will be appreciated by the skilled artisan, each layer 48, 50, 52, 54, 56 and 58 will vary slightly in their dimensions, depending on their respective bending radius. Further, the layers 48, 50, 52 and 54 are individually preformed. The remaining layers 56 and 58 are sufficiently thin to be bent into shape without being preformed. Specifically, the preforming of layers 48, 50, 52 and 54 is accomplished as a so-called “flat wrap” wherein each layer is individually bent about its respective center line 24. As intended for the present invention, this “flat wrap” is preferably accomplished at a temperature in a range between three hundred and three hundred and fifty degrees Fahrenheit (300-350 F°). The result of the “flat wrap” is that each of the layers 48, 50, 52, 54, 56 and 58 are shaped as shown for the windshield 10 in FIG. 1A.

For the transformation of layers 22 into the windshield 10, the preformed layers are prepared with an adhesive (not shown) placed between juxtaposed layers 22 (i.e. the layers 48, 50, 52, 54, 56 and 58). The combination of layers 22 are then juxtaposed as described above to establish a common edge 60 (see FIG. 2). Next, a vacuum bag (not shown) is installed along the edge 60 of the unit (i.e. the combination of layers 22). With the vacuum bag installed, a vacuum of approximately twenty three inches of mercury is drawn to help compress the layers 22 (i.e. the layers 48, 50, 52, 54 and 56) together. The unit (layers 48, 50, 52, 54 and 56) with the installed vacuum bag is then placed in an autoclave and is subjected to a pressure greater than about fifty pounds per square inch (>50 psi). This autoclaving continues for about one hour. During this period of time, the temperature inside the autoclave is maintained at a temperature in a range between one hundred and eighty five and two hundred and sixty degrees Fahrenheit (185-260 F°). When taken from the autoclave, the windshield 10 has been constructed and is ready for installation.

In order to install the windshield 10 onto the aircraft 12, a carbon frame 62 is bonded to the first polycarbonate layer 48 by any means well known in the pertinent art. Similarly, a carbon frame 64 is bonded to the second polycarbonate layer 50. The carbon frames 62 and 64 are then affixed to the fuselage 14 of aircraft 12. Preferably this is done using a nut 66 and bolt 68 substantially as shown in FIG. 4.

While the particular Unitary One-Piece Windshield as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A windshield for an aircraft having a fuselage defining a longitudinal axis, the windshield comprising:
a single transparent unit substantially surrounding a pilot of the aircraft during flight, wherein the unit defines a straight center line bifurcating the unit into substantially identical first and second portions, and further wherein the unit is bent along the center line with the first portion symmetrical to the second portion relative to a central plane defined by the intersection of the centerline of the unit and the longitudinal axis of the fuselage; and
a means for affixing the unit to the fuselage.

2. A windshield as recited in claim 1 wherein the first portion and the second portion each extend through an arcuate distance “d”, measured from the centerline, to provide a pilot, when sitting between the first portion and the second portion, an unobstructed field of vision through an arc of approximately two hundred and twenty degrees (220°).

3. A windshield as recited in claim 1 wherein each portion of the unit is continuously curved between the center line and a respective end point of the portion.

4. A windshield as recited in claim 1 wherein the transparent unit comprises, in sequence:
an outer layer of an acrylic;
a first layer of a polycarbonate bonded to the outer layer;
a second layer of a polycarbonate bonded to the first layer; and
an inner layer of an acrylic bonded to the second layer.

5. A windshield as recited in claim 4 further comprising a heating layer bonded to the outer layer to position the outer layer between the heating layer and the first layer.

6. A windshield as recited in claim 5 wherein the heating layer comprises a Mylar® material with a metallic heating element embedded therein.

7. A windshield as recited in claim 6 wherein a polyurethane adhesive is used to bond the heating layer, the outer layer, the first and second layers and the inner layer together.

8. A windshield as recited in claim 1 wherein the transparent unit includes at least one compound curve.

9. A cabin for a fuselage of an aircraft which comprises:
a hollow, substantially cylindrical shaped body section having a tail end and a nose end, with the body section having an extension projecting forward therefrom and with the body section and its extension being symmetrically divided by a central plane;
an aft bulkhead affixed to the tail end of the body section to cover the tail end and establish a pressurized seal therebetween;
a forward bulkhead affixed to a portion of the nose end of the body section to establish a pressurized seal therebetween, with the forward bulkhead symmetrical relative to the central plane and distanced from the extension of the body section to establish a gap therebetween; and
a single transparent unit dimensioned to fill the gap, with the transparent unit affixed between the extension of the body section and the forward bulkhead to enclose the cabin and establish a pressurized seal for the cabin.

10. An aircraft cabin as recited in claim 9 wherein the transparent unit substantially surrounds a pilot during flight and defines a straight center line bifurcating the unit into substantially identical first and second portions, and further wherein the unit is bent along the center line with the first portion symmetrical to the second portion relative to the central plane.

11. An aircraft cabin as recited in claim 10 wherein the first portion and the second portion each extend through an arcuate distance “d”, measured from the centerline, to provide the pilot, when sitting between the first portion and the second portion, an unobstructed field of vision through an arc of approximately two hundred and twenty degrees (220°).

12. An aircraft cabin as recited in claim 11 wherein each portion of the unit is formed as a continuous curve between the center line and a respective end point of the portion.

13. An aircraft cabin as recited in claim 12 wherein the transparent unit includes at least one compound curve.

14. A method for manufacturing a cockpit windshield for an aircraft having a fuselage defining a longitudinal axis, the method comprising the steps of:
individually forming a plurality of layers, the plurality including a heating layer of Mylar®, an outer layer of an acrylic, a first layer of a polycarbonate, a second layer of a polycarbonate, and an inner layer of an acrylic;
laminating the layers together, in sequence, with the outer layer bonded to the heating layer, the first layer bonded to the outer layer, the second layer bonded to the first layer, and the inner layer bonded to the second layer to collectively create a single transparent unit; and
affixing the unit to the fuselage.

15. A method as recited in claim 14 wherein each layer of the unit defines a straight center line respectively bifurcating each layer into substantially identical first and second portions, and wherein the forming step is accomplished by bending each layer along its center line with the first portion symmetrical to the second portion relative to a central plane defined by the intersection of the centerline of the unit and the longitudinal axis of the fuselage.

16. A method as recited in claim 15 wherein the bending of each layer is accomplished as a flat wrap.

17. A method as recited in claim 15 wherein the bending of each layer is accomplished at a temperature in a range between three hundred and three hundred and fifty degrees Fahrenheit (300-350 F).

18. A method as recited in claim 14 wherein the transparent unit has an edge, and the laminating step further comprises the steps of:
placing an adhesive between juxtaposed layers of the unit;
installing a vacuum bag over the edge of the unit to establish a pressure therein below about twenty five inches of mercury; and
autoclaving the unit with the installed vacuum bag at a pressure greater than about fifty pounds per square inch (>50 psi), for about one hour, at a temperature in a range between one hundred and eighty five and two hundred and sixty degrees Fahrenheit (185-260 F°).

19. A method as recited in claim 14 wherein the affixing step is accomplished by the steps of:
bonding a first carbon frame to the first layer and a second carbon frame to the second layer; and
bolting the first carbon frame and the second carbon frame to the fuselage.

20. A method as recited in claim 14 wherein the fuselage comprises a hollow, substantially cylindrical shaped body section having a tail end and a nose end, with the body section having an extension projecting forward therefrom and with the body section and its extension being symmetrically divided by a central plane, and further wherein the fuselage comprises an aft bulkhead affixed to the tail end of the body section to cover the tail end and establish a pressurized seal therebetween and a forward bulkhead affixed to a portion of the nose end to establish a pressurized seal therebetween, with the forward bulkhead symmetrical relative to the central plane and distanced from the extension of the body section to establish a gap therebetween; and wherein the affixing step is accomplished by affixing the transparent unit between the extension of the body section and the forward bulkhead to enclose the cabin and establish a pressurized seal for the cabin.
